(19) United States
(12) Patent Application Publication
(10) Pub. No.: US 2003/0073560 A1
(43) Pub. Date: Apr. 17, 2003

(54) Stops for sheet media folding apparatus

(76) Inventor: Gerardo E. Baldini, Jalisco (MX)

Correspondence Address: HEWLETT-PACKARD COMPANY, Intellectual Property Administration, P.O. Box 272400, Fort Collins, CO, 80527-2400, US

(21) Appl. No.: 09/976,386

(22) Filed: Oct. 11, 2001

(51) Int. Cl. B31F 1/10

(52) U.S. Cl. 493/434

(57) ABSTRACT

Sheet media is folded in a folding apparatus. The apparatus has an input conveyor, first and second pairs of positioning rollers, first and second folding mechanisms, and first and second media paths. The media is conveyed into the apparatus with the input conveyor. The input conveyor may be a pair of input rollers or any other type of media conveyor. The media is buckled by capturing and positioning the media with a first pair of positioning rollers, while the media is conveyed with the input conveyor. The buckle in the media is captured with the first folding mechanism and drawn from the input conveyor and the first pair of positioning rollers. The first folding mechanism may be a pair of folding rollers or any other mechanism for capturing a buckle in the media. The media is buckled again by capturing and positioning the media with the second pair of positioning rollers, while the media is drawn by the first folding mechanism. The buckle in the media is captured by the second folding mechanism and drawn from the first folding mechanism and the second pair of positioning rollers. The second folding mechanism may be a pair of folding rollers, one of the pair of folding rollers of the first folding mechanism and a third folding roller, or any other mechanism for capturing a buckle in the media.

### FIELD OF THE INVENTION

This invention relates in general to sheet media handling and, more particularly, to stops in a sheet media folding apparatus.

### BACKGROUND OF THE INVENTION

Sheet media folding apparatus fold sheet media, such as paper. Such apparatus are common and well known. Although conventional sheet media folding apparatus take a variety of forms, each has many similarities.

Conventional folding apparatus include a paper path through which paper travels, stops for positioning the sheet media in the paper path and causing the sheet media to buckle, and a folding mechanism for grasping the buckle in the sheet media. The stops are often adjustable, either manually or automatically based on the length of the paper and the desired location of the fold.

The stops are adjusted by moving them within the paper path relative to the folding mechanism. The stops obstruct the paper path, preventing the sheet media from continuing through the paper path. The distance between the stops and the folding mechanism is the location of the fold.

The adjustable stops of a conventional folding apparatus require time to adjust for each change in position. Furthermore, since the stops are adjustable within the paper path, the paper path must be long enough to accommodate the longest sheet media intended for use with the folding apparatus.

### SUMMARY OF THE INVENTION

According to principles of the present invention, sheet media is folded in a folding apparatus. The apparatus has an input conveyor, first and second pairs of positioning rollers, first and second folding mechanisms, and first and second media paths. The media is conveyed into the apparatus with the input conveyor. The media is buckled by capturing and positioning the media with a first pair of positioning rollers, while the media is conveyed with the input conveyor. The buckle in the media is captured with the first folding mechanism and drawn from the input conveyor and the first pair of positioning rollers. The media is buckled again by capturing and positioning the media with the second pair of positioning rollers, while the media is drawn by the first folding mechanism. The buckle in the media is captured with the second folding mechanism and drawn from the first folding mechanism and the second pair of positioning rollers.

According to further principles of the present invention, the input conveyor may be a pair of input rollers or any other type of media conveyor. The first folding mechanism may be a pair of folding rollers or any other mechanism for capturing a buckle in the media. The second folding mechanism may be a pair of folding rollers, one of the pair of folding rollers of the first folding mechanism and a third folding roller, or any other mechanism for capturing a buckle in the media.

### DESCRIPTION OF THE DRAWINGS

FIG. 1 diagrammatically illustrates the folding apparatus of the present invention.

FIG. 2 is a flow chart illustrating one embodiment of a method of the present invention for folding sheet media.

### DETAILED DESCRIPTION OF THE INVENTION

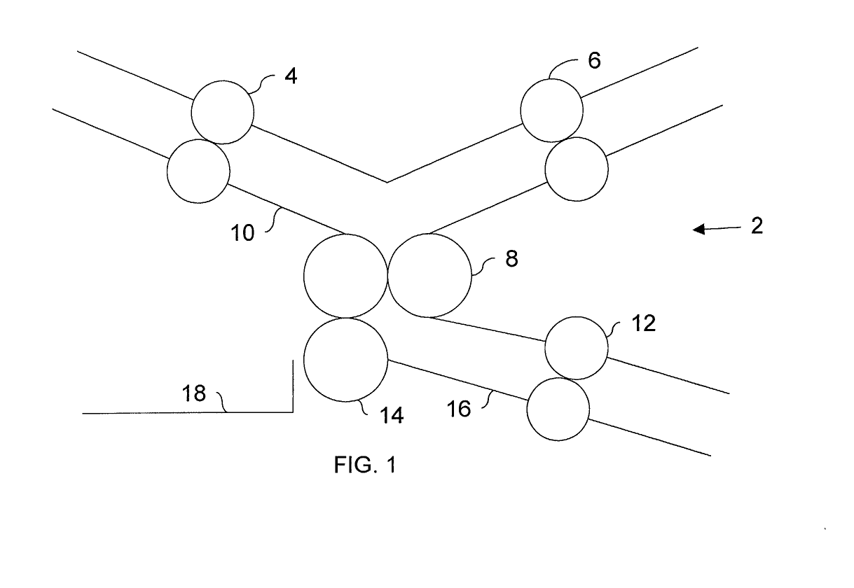

Illustrated in FIG. 1 is a sheet media folding apparatus 2. Folding apparatus 2 includes an input conveyor 4, a first pair of positioning rollers 6, a first folding mechanism 8, a first media path 10, a second pair of positioning rollers 12, a second folding mechanism 14, a second media path 16, and an output bin 18.

Apparatus 2 is shown without a housing. Apparatus 2 does not require a housing for operation, but a housing may be desirable to insulate against noise and prevent the introduction of unwanted matter into the apparatus.

A controller (not shown) is desirable for the operation of apparatus 2. The controller is either integral to apparatus 2 or separate from apparatus 2. The controller controls input conveyor 4, first pair of positioning rollers 6, first folding mechanism 8, second pair of positioning rollers 12, and second folding mechanism 14. The controller is any device or system able to perform the required functions as discussed herein.

Input conveyor 4 is any device able to convey sheet media into apparatus 2. Examples of input conveyor 4 include a pair of input rollers, a single input roller, a picking mechanism, and any other conveyor system for sheet media.

First pair of positioning rollers 6 is any roller pair controllable by the controller configured to receive the sheet media, advancing the sheet media for a distance, stopping the sheet media to cause a buckle in the media, retrieving the sheet media, and releasing the sheet media. First pair of rollers 6 is any suitable size and material for handling the sheet media in apparatus 2.

First folding mechanism 8 is positioned between input conveyor 4 and first pair of positioning rollers 6. First folding mechanism 8 is any device configured to capture the buckle in the media and draw the media from input conveyor 4 and first pair of positioning rollers 6. One example of first folding mechanism 8 is a pair of folding rollers. Other suitable mechanisms for folding the sheet media are within the scope of the present invention.

First media path 10 is any article configured to guide the media between input conveyor 4, first pair of positioning rollers 6, and first folding mechanism 8. Examples of media path 10 include a solid surface chamber within apparatus 2 and a permeated chamber within apparatus 2.

Second pair of positioning rollers 12 is any roller pair controllable by the controller configured to receive the sheet media, advancing the sheet media for a distance, stopping the sheet media to cause a buckle in the media, retrieving the sheet media, and releasing the sheet media. Second pair of rollers 12 is any suitable size and material for handling the sheet media in apparatus 2.

Second folding mechanism 14 is positioned between input conveyor 4 and second pair of positioning rollers 6. Second folding mechanism 14 is any device configured to capture the buckle in the media and draw the media from first folding mechanism 8 and second pair of positioning rollers 12. One example of second folding mechanism 14 is a pair of folding rollers. Another example of second folding mechanism 14 is one of a pair of folding rollers of first folding mechanism 8 and a third folding roller. Other suitable mechanisms for folding the sheet media are within the scope of the present invention.

Second media path 16 is any article configured to guide the media between first folding mechanism 8, second pair of positioning rollers 14, and second folding mechanism 8. Examples of media path 16 include a solid surface chamber within apparatus 2 and a permeated chamber within apparatus 2.

Output bin 18 is any repository for sheet material folded within apparatus 2. Output bin 18 is not required for the functioning of the present invention. An output bin 18 is desirable for retaining folded sheet media in an orderly stack.

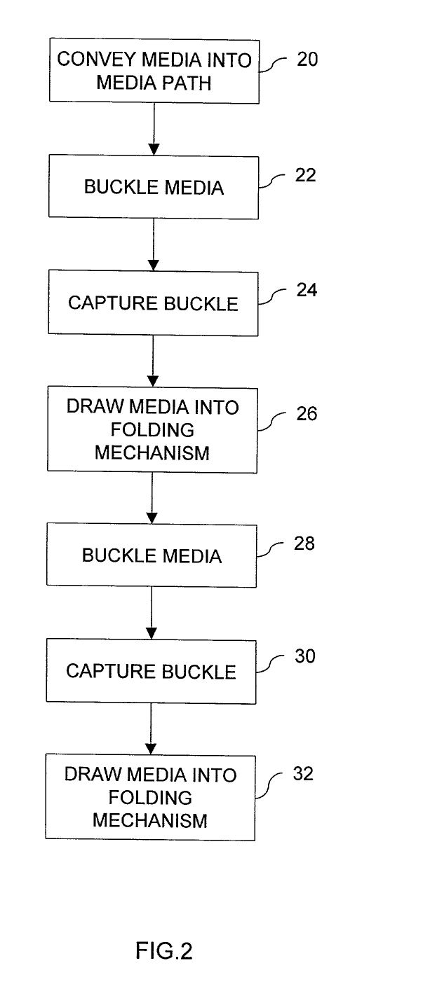

FIG. 2 is a flow chart representing steps of one embodiment of the present invention. Although the steps represented in FIG. 2 are presented in a specific order, the present invention encompasses variations in the order of steps. Furthermore, additional steps may be executed between the steps illustrated in FIG. 2 without departing from the scope of the present invention.

A sheet media is conveyed 20 by input conveyor 4 into first media path 10. While the media is being conveyed by input conveyor 4, first pair of positioning rollers 6 captures and positions the media. When the media is positioned in the desired location, first pair of positioning rollers 6 holds the media firmly in position. The continued conveyance of the sheet media by input conveyor 4 into first media path 10 causes the media to buckle 22.

The buckle is captured 24 by first folding mechanism 8. The captured buckle is then drawn 26 through first folding mechanism 8 to fold the media.

If a second fold is not desired, the media is moved until free of first folding mechanism, then pulled by second folding mechanism 14, and ejected into output bin 18. If a second fold is desired, the media is again buckled 28 by capturing and positioning the media with second pair of positioning rollers 12, while the media is being drawn by first folding mechanism 8. The buckle is then captured 30 with second folding mechanism 14. The captured buckle is drawn 32, with second folding mechanism 14, from first folding mechanism 8 and second pair of positioning rollers 12.

The foregoing description is only illustrative of the invention. Various alternatives and modifications can be devised by those skilled in the art without departing from the invention. Accordingly, the present invention embraces all such alternatives, modifications, and variances that fall within the scope of the appended claims.

What is claimed is:

1. A folding apparatus for sheet media, the apparatus comprising:
(a) an input conveyor configured to convey the media into the apparatus;
(b) a first pair of positioning rollers configured to buckle the media by capturing and positioning the media while the media is conveyed into the apparatus;
(c) a first folding mechanism positioned between the input conveyor and the first pair of positioning rollers the first folding mechanism configured to capture the buckle in the media and draw the media from the input conveyor and the first pair of positioning rollers; and,
(d) a first media path configured to guide the media between the input conveyor, the first pair of positioning rollers, and the first folding mechanism.

2. The apparatus of claim 1 wherein the input conveyor includes a pair of input rollers.

3. The apparatus of claim 1 wherein the first folding mechanism includes a pair of folding rollers.

4. The apparatus of claim 1 further including a controller configured to control motion in the input conveyor, first pair of positioning rollers, and first folding mechanism.

5. The apparatus of claim 1 further including:
(a) a second pair of positioning rollers configured to buckle the media by capturing and positioning the media while the media is drawn by the first folding mechanism;
(b) a second folding mechanism positioned between the first folding mechanism and the second pair of positioning rollers the second folding mechanism configured to capture the buckle in the media from the second pair of positioning rollers and draw the media from the first folding mechanism and the second pair of positioning rollers; and,
(c) a second media path configured to guide the media between the first folding mechanism, the second pair of positioning rollers, and the second folding mechanism.

6. The apparatus of claim 5 wherein the second folding mechanism includes a pair of folding rollers.

7. The apparatus of claim 5 wherein the first folding mechanism includes a pair of folding rollers and wherein the second folding mechanism includes one of the pair of folding rollers of the first folding mechanism and a third folding roller.

8. The apparatus of claim 5 further including a controller configured to control motion in the second pair of positioning rollers and the second folding mechanism.

9. A method for folding sheet media, the method comprising:
(a) conveying the media with an input conveyor;
(b) while the media is conveyed with the input conveyor, buckling the media by capturing and positioning the media with a first pair of positioning rollers;
(c) capturing the buckle in the media with a first folding mechanism positioned between the input conveyor and the first pair of positioning rollers; and,
(d) drawing the media with the first folding mechanism, from the input conveyor and the first pair of positioning rollers.

10. The method of claim 9 wherein conveying the media with an input conveyor includes conveying the media with a pair of input rollers.

11. The method of claim 9 wherein capturing the buckle in the media with a first folding mechanism includes capturing the buckle in the media with a pair of folding rollers.

12. The method of claim 9 further including:
(a) buckling the media by capturing and positioning the media with a second pair of positioning rollers, while the media is drawn by the first folding mechanism;
(b) capturing the buckle in the media with a second folding mechanism positioned between the first folding mechanism and the second pair of positioning rollers; and,
(c) drawing the media with the second folding mechanism, from the first folding mechanism and the second pair of positioning rollers.

13. The method of claim 12 wherein capturing the buckle in the media with a second folding mechanism includes capturing the buckle in the media with a pair of folding rollers.

14. The method of claim 12 capturing the buckle in the media with a second folding mechanism includes capturing the buckle in the media with one of the pair of folding rollers of the first folding mechanism and a third folding roller.

15. A folding apparatus for sheet media, the apparatus comprising:
(a) an input conveyor configured to convey the media into the apparatus;
(b) a first pair of positioning rollers configured to buckle the media by capturing and positioning the media while the media is conveyed into the apparatus;
(c) a first folding mechanism positioned between the input conveyor and the first pair of positioning rollers, the first folding mechanism configured to capture the buckle in the media and draw the media from the input conveyor and the first pair of positioning rollers;
(d) a first media path configured to guide the media between the input conveyor, the first pair of positioning rollers, and the first folding mechanism;
(e) a second pair of positioning rollers configured to buckle the media by capturing and positioning the media while the media is drawn by the first folding mechanism;
(f) a second folding mechanism positioned between the first folding mechanism and the second pair of positioning rollers, the second folding mechanism configured to capture the buckle in the media from the second pair of positioning rollers and draw the media from the first folding mechanism and the second pair of positioning rollers; and,
(g) a second media path configured to guide the media between the first folding mechanism, the second pair of positioning rollers, and the second folding mechanism.

16. The apparatus of claim 15 wherein the input conveyor includes a pair of input rollers.

17. The apparatus of claim 15 wherein the first folding mechanism includes a pair of folding rollers.

18. The apparatus of claim 17 wherein the second folding mechanism includes one of the pair of folding rollers of the first folding mechanism and a third folding roller.

19. The apparatus of claim 15 wherein the second folding mechanism includes a pair of folding rollers.

20. The apparatus of claim 15 further including a controller configured to control motion in the input conveyor, first pair of positioning rollers, first folding mechanism, second pair of positioning rollers, and second folding mechanism.
